(19) United States
(12) Patent Application Publication
(10) Pub. No.: US 2006/0123009 A1
(43) Pub. Date: Jun. 8, 2006

(54) Flexible database generators

(75) Inventors: Nicolas Bruno, Redmond, WA (US); Surajit Chaudhuri, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/005,776

(22) Filed: Dec. 7, 2004

(51) Int. Cl. G06F 17/30

(52) U.S. Cl. 707/10

(57) ABSTRACT

A flexible, easy to use, and scalable framework for database generation and mappings of synthetic distributions to the framework. The framework discloses a specification language, database primitives, aspects of a runtime system, and an extension to create table SQL statements, to generate databases with complex synthetic distributions and inter-table correlations. The framework facilitates generation of a data generator which can output the synthetic data distribution. The data distribution includes at least one of a complex intra-table correlation and a complex inter-table correlation. The framework further comprises an annotations component that facilitates annotation of a relational database statement (e.g., a CREATE TABLE statement) which specifies concisely how a table will be populated. The framework further comprises a language component (e.g., a Data Generation Language (DGL)) that specifies the data distribution.

### TECHNICAL FIELD

This invention is related to databases, and more specifically, to generating synthetic databases for testing purposes.

### BACKGROUND OF THE INVENTION

When designing a new database technique, it is crucial to evaluate its effectiveness for a wide range of input data distributions. Such systematic evaluation can help identify design problems, validate hypothesis, and evaluate the robustness of the proposed technique. Evaluation and applicability of many database techniques, ranging from access methods, histograms, and optimization strategies to data exploration and mining, crucially depend on the capability of these techniques to cope with varying data distributions in a robust way. However, comprehensive real data is often hard to obtain. Moreover, there is no flexible data generation framework capable of modeling varying rich data distributions. This has required that individual researchers develop their own ad hoc data generators for specific tasks. However, the resulting data distributions are often hard to reproduce, analyze, and modify, thus preventing wider usage of these data distributions.

Consider, for instance, a new histogram technique for cardinality estimation. Since these techniques often use heuristics, it is very difficult to analyze them analytically. Instead, a common practice to evaluate a new proposal is to analyze its efficiency and quality of approximations with respect to a set of data distributions. For such a validation to be meaningful, input data sets must be carefully chosen to exhibit a wide range of patterns and characteristics. In the case of multidimensional histograms, it is crucial to use data sets that display varying degrees of column correlation, and also different levels of skew in the number of duplicates per distinct value. Note that histograms are not just used to estimate the cardinality of range queries, but also to approximate the result size of complex queries that might involve joins and aggregations. Therefore, a thorough validation of a new histogram technique needs to include data distributions with correlations that span over multiple tables (e.g., correlation between columns in different tables connected via foreign key joins).

Another problem that requires a wide set of test data distributions is automatic physical design for database systems. Recent algorithms that address this problem are complex and depend on many variables. It is therefore advisable to check whether the expected behavior of a new approach (both in terms of scalability and quality of recommendations) is satisfied for a wide variety of databases. For that purpose, the test databases should not be simplistic, but instead show complex intra- and inter-table correlations. As an example, consider the popular TPC-H benchmark. While it exhibits a rich schema and complex workloads, the generated data distributions are mostly uniform and independent. In the context of physical database design, of interest is how recommendations would change if the data distribution shows different characteristics. For example, what if the number of line items per order follows a Zipfian distribution? What if customers buy line items that are supplied exclusively by vendors in their nation? What if customer balances depend on the total price of their respective open orders? Note that these constraints require the ability to capture correlation and dependencies across relations.

In many situations, synthetically generated databases are the only choice: real data might not be available at all, or it might not be comprehensive enough to thoroughly evaluate the considered system. Unfortunately, there is no available data generation framework that is capable of modeling varying rich data distributions like the examples described above. This has led individual researchers to develop their own ad-hoc data generators. Usually the resulting data generation settings are not clearly documented and details become hidden in the particular implementations. In consequence, the resulting data distributions are often hard to reproduce if the generator is not available. Moreover, because each generator exposes its unique set of characteristics, it is often difficult to analyze and introduce minor changes to the resulting distributions even when the specific implementations are made available.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Described herein is a flexible, easy to use, and scalable framework for database generation and mappings of several proposed synthetic distributions to the framework. Specifically, the invention discloses a specification language, database primitive, aspects of a runtime system, and an extension to create table SQL statements, to generate databases with complex synthetic distributions and inter-table correlations. Many synthetic distributions proposed in the art can be easily specified using the disclosed language and that the resulting data generators are efficient.

The invention disclosed and claimed herein, in one aspect thereof, comprises a framework which facilitates generation of a data generator which can output a synthetic data distribution. The data distribution includes at least one of a complex intractable correlation and a complex inter-table correlation. The framework further comprises an annotations component that facilitates annotation of a relational database statement (e.g., a CREATE TABLE statement) which specifies concisely how a table will be populated. The framework further comprises a language component (e.g., a Data Generation Language (DGL)) that specifies the data distribution.

The language component utilizes scalars, a fixed-size heterogeneous sequence of the scalars, iterators, and tables. The language component facilitates generation of a program that interfaces to a relational database management system (RDBMS) to process RDBMS algorithms. The language component is extensible such that a basic set of primitive iterators can be extended with a new user-defined iterator. The basic set of primitive iterators includes statistical distributions, discrete data distributions, and continuous data distributions.

In another aspect of the subject invention, a computer-readable medium is provided having computer-executable instructions for performing a method of creating a data distribution. The method includes providing a specification of the data distribution via a data generation language (DGL), the data distribution is synthetic and includes inter-table correlations; creating at least one of, a DGL program that includes function definitions and an expression, and a set of annotated database statements; compiling the DGL program into an intermediate code; compiling the intermediate code to obtain a data generator; and executing the data generator to output the synthetic data distribution.

In yet another aspect thereof, an artificial intelligence component is provided that employs a probabilistic and/or statistical-based analysis to prognose or infer an action that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a generator framework that facilitates the generation of a data distribution generator in accordance with the subject invention.

FIG. 2 illustrates graphically an output distribution of a given iterator in accordance with the subject invention.

FIG. 3 illustrates a methodology of program evaluation in accordance with the invention.

FIG. 4A illustrates a diagram of a simple DGL (Data Generation Language) program and corresponding DAG (Directed Acyclic Graph) where each node has exactly one consumer, in accordance with the invention.

FIG. 4B illustrates a diagram of a simple DGL program and corresponding DAG where a node has multiple consumers, in accordance with the invention.

FIG. 4C illustrates a diagram of a simple DGL program and corresponding DAG where the same iterator has multiple consumers, in accordance with the invention.

FIG. 5A shows a DAG of a buffering scenario in accordance with the invention.

FIG. 5B illustrates a DAG of iterator duplication in accordance with the invention.

FIG. 6 illustrates a methodology of determining the trade-offs between buffering and duplication of a shared iterator in accordance with the invention.

FIG. 7 illustrates a methodology of annotating a SQL CREATE TABLE statement in accordance with the invention.

FIG. 8 illustrates a methodology of avoiding buffering iterators in accordance with the invention by employing an optimization which uses a proxy iterator.

FIG. 9 illustrates one implementation of DGL in accordance with the subject invention.

FIG. 10 illustrates a methodology for defining new primitives in DGL in accordance with the invention.

FIG. 11 illustrates a methodology of iterator buffering at runtime in accordance with the invention.

FIG. 12 illustrates one implementation for proving buffering according to the invention.

FIG. 13 illustrates a database generator framework that utilizes an artificial intelligence component to learn and automate one or more features in accordance with the invention.

FIG. 14 illustrates a block diagram of a computer operable to execute the disclosed architecture.

FIG. 15 illustrates a schematic block diagram of an exemplary computing environment in accordance with the subject invention.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Disclosed herein is a flexible framework that specifies and generates databases that can model data distributions with complex intra- and inter-table correlations. A special purpose language called DGL (Data Generation Language) is also introduced that has a functional flavor. DGL has characteristics of flexibility and extensibility. DGL is sufficiently powerful to generate a large variety of data distributions. A main abstraction in DGL is the concept of an iterator, which provides a stream of rows. Iterators are first class citizens and can be combined and modified in different ways to obtain complex data correlations.

DGL is scalable. Large data distributions should be generated in a relatively short amount of time. In addition to the core DGL functionality, a DGL program can exploit an underlying DBMS (Database Management System), such as a Relational DBMS (RDBMS) and leverage its well-tuned and scalable algorithms (e.g., sorting, joins, and aggregates). The following description focuses on a RDBMS. However, it is to be appreciated that other database management systems can benefit from the disclosed database generator framework.

DGL can also be used to further simplify the specification of synthetic relational databases by adding DGL annotations to SQL (Structured Query Language) CREATE TABLE statements, which concisely specify how a table should be populated.

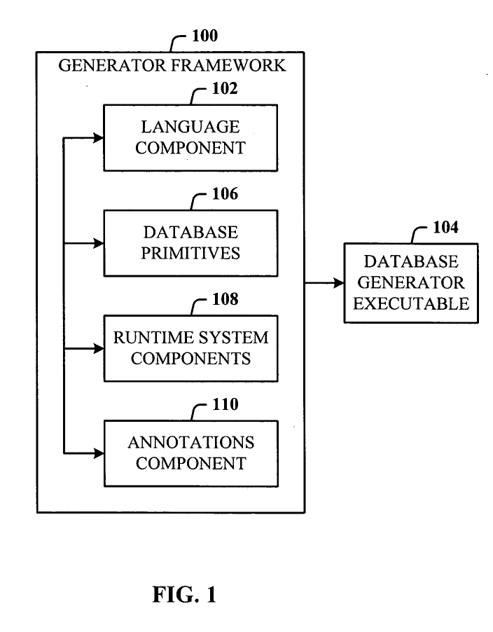

Referring initially to the drawings, FIG. 1 illustrates a generator framework 100 that facilitates the generation of a data distribution generator in accordance with the subject invention. The framework 100 includes a number of components and aspects that facilitate the specification and generation of database that can model data distributions having complex intra-table correlations and complex inter-table correlations. The framework 100 includes a language component 102 that includes a language used to generate synthetic data distributions. The language component 102 includes scalars, rows, iterators, and tables that specify the model for creating a database generator executable file or program 104 that generates the data distribution. The framework 100 also includes database primitive iterators 106 that are extensible for the creation of new user-defined primitives. The framework 100 accesses runtime system components 108 that include a runtime library and other user-defined libraries. An annotations component 110 facilitates the addition of annotations to SQL CREATE TABLE statements that precisely specify how a table is to be populated.

Following are examples of data types in DGL, and the various operations that each data type support. Scalars are the most basic type in DGL, and are further subdivided into integers (Int), double precision real numbers (Double), strings (String), and dates (DateTime). DGL supports the traditional operations over each scalar type, such as arithmetic and comparison operations for integers and real numbers, and concatenation and substring operations for strings.

Rows are fixed size heterogeneous sequences of scalars. For instance, R=[1.0, 2, ‘John Smith’] is a row of type [Double, Int, String]. The expression dim (R) returns the number of columns in R, and R [i] returns the i^{th} column of R (0≦i<dim(R). In the example above, dim(R)=3,R[0]=1.0, and R[0]+R[1]=3.0. The operator ++combines rows, so [2,‘John’ ]++[‘Smith’,4]=[2,‘John’,‘Smith’,4]. Finally, operators defined over scalars can use rows as operands provided that (1) each operand is of the same size, and (2) each column in the operands is compatible with the operator. In that case, the result is a new row where each column is obtained by applying the operator to the individual operands' columns. Then, [1,2,3]+[4,5,6]=[5,7,9], and both [1,2]+[2,3,4] and [1,‘John’]+[3, 4] are invalid expressions.

Iterators are objects in DGL. Iterators support the operations open (which initializes the iterator), and getNext (which returns a new Row or an end-of-iterator special value). For instance, the iterator Step (f, t, s) returns rows {[f], [f+s], [f+2 s], . . . , [f+ks]} where f+k(s+1)≧t. As another example, for a row R, the iterator Constant (R) returns the infinite sequence {R, R, R, . . . }. All operations on rows can also be applied to iterators. The result of such operations is a new iterator that, for each getNext request, obtains a new row from each operand, applies the operator to such rows, and returns the resulting row. Consider I1=Step(1,100,2), I2=step(5,21,3), and I3=Constant([10,20,30]). In that case,

| | |
|---|---|
| I3[1] = | {[20], [20],...} |
| I1++I2 = | {[1,5], [3,8],...,[11,20]} |
| I1+I2−I3[0] = | {[-4], [1],...,[21]} |

Tables are in-memory instances of (finite) iterators provided for efficiency purposes. The notation T [i] refers to the i^{th} row in table T.

DGL applies implicit casts to operands depending on the expression context. Consider Step (1,100,1)++[5]. The left operand is an iterator and the right operand is a row. In this case, the row is implicitly promoted to iterator Constant([5]). Similarly, in [1]+3, the integer 3 is converted into a single-column row [3]. Iterators and tables can be used interchangeably (but tables must fit in memory). Implicit casts are relied on hereinafter in the description.

If Step and Constant were the only available iterators in DGL there would not be many interesting data sets that could be generated. One strength of DGL is the existence of a large set of primitive iterators and the capability to extend this basic set with new user-defined primitives. Following are some built-in iterators in DGL.

Distributions. DGL natively supports many statistical distributions as built-in iterators. For instance, the built-in function Uniform takes two input iterators and returns an iterator that produces a multidimensional uniform distribution. Consider I=Uniform(iLO, iHI). Each time a new row is required from this iterator, I retrieves the next row from iterators iLO and iHI (denoted rLO and rHI) and produces a new row (denoted rout) where rOut[i] is a random number between rLO[i] and rHI [i]. As an example, Uniform(Constant([5,5]), Constant([10,15])) is an iterator that produces an infinite stream of uniformly distributed 2-dimensional points (x,y) where 5≦x≦10 and 5≦y≦15. Due to implicit casts, the same iterator can be written as Uniform([5,5], [10,15]).

In addition to Uniform, DGL supports a wide variety of discrete and continuous data distributions, including UniformInt (a discrete version of Uniform), Normal, Exponential, Zipfian, and Poisson.

SQL and Relational Queries. Two primitive functions, Persist and Query, are provided to bridge DGL and an underlying RDBMS. Persist takes an iterator I and an optional string s as its input, bulk-loads all the rows provided by I in a database table named s, and returns the string s. If no input string is provided, DGL generates a unique name for a temporary table in the DBMS. In the latter case, the bulk-loaded table contains one additional column, id, which stores the sequential number of the corresponding row. The remaining columns in the table are called v0, v1, and so on. For instance, if Persist(Step(15,1000,6)++5) returns #Tmp1, a new temporary table #Tmp1 was created in the DBMS as a side effect with the following schema and values:

| id | v0 | v1 |
|---|---|---|
| 0 | 15 | 5 |
| 1 | 21 | 5 |
| . . . | . . . | . . . |
| 164 | 999 | 5 |

Conversely, Query takes a parameterized query string sqlStr and a sequence of table names T1, . . . , Tk that exist in the DBMS, and (1) replaces the i^{th} parameter in the query with the value Ti, (2) executes the resulting query, and (3) returns an iterator that provides the query results one row at a time. The i^{th} parameter is denoted as <i> in the parameterized string sqlStr. The expression below returns a random permutation of all odd numbers smaller than 1000:

Query( “SELECT v0 FROM <0> ORDER BY v1”,

PERSIST( Step(1, 1000, 2) ++ Uniform(0, 1) ) )

In the expression above, the argument of Persist is an iterator of two columns, where the first column consists of all odd numbers between 1 and 1000, and the second column is a random number between 0 and 1. This iterator is persisted in the database as a temporary table, and is subsequently read in order of the random column v1. This example shows that instead of reinventing robust and scalable algorithms to sort, aggregate, or join rows, the underlying DBMS is reused. While, strictly speaking, the loading/query cycle might incur some overhead, it is quite acceptable while providing much additional functionality and robustness.

Non-blocking duplicate elimination. DGL provides a primitive iterator, dupFilter, which takes as input an iterator I, two numbers f1 and f2, and a row of indexes cols, and controls the degree of uniqueness of I. Each time getNext is called on I2=dupFilter(I, f1, f2, cols), the next row R is obtained from the input iterator I and returned a fraction f1 of the time if the columns of R specified by cols were not seen previously, or a fraction f2 of the time otherwise (f1+f2 is not necessarily equal to one). A pseudo code of dupFilter.getNext is provided as follows.

| dupFilter.getNext ( ) | |
|---|---|
| local (I: Iterator, | |
| | pDup, pNoDup: Double, |
| | cols=[c1 , ..., cn]: Row) |
| 01 while(true) | |
| 02 | R = I.getNext( ) |
| 03 | if (R = end-of-iterator) return R |
| 04 | isDup = [ R[c1 ], ..., R[cn] ] is duplicate |
| 05 | if ( isDup && Random<pDup) \|\| |

(!isDup && Random<pNoDup)

| | |
|---|---|
| 06 | return R |

This operator is useful in the context of infinite streams, since it is not possible to first persist them into a temporary table and then use SQL to filter duplicates. In one implementation, DGL supports two implementations of dupFilter which vary on how line 04 is implemented: dupFilterMem maintains a hash table of all unique values in memory, and dupFilterDB creates a temporary table on the database system with a unique constraint and uses it to check whether a new value was already inserted. These alternatives balance space consumption and efficiency.

Other DGL primitive iterators include:

Top(I:Iterator, k:Int), which produces only the first k rows of I.

Union(I1, I2:Iterator), which produces all rows from I1 followed by those from I2.

ProbUnion(I1, I2:Iterator, p:Double), which is similar to Union(I1,I2) but interleaves rows from I1 and I2 with probability p and 1−p, respectively.

tableApply(T:Table, I:Iterator of [Int]) which returns, at each step, the element in table T at position given by the next element from I.

Duplicate (IR:Iterator, IF:Iterator of [Int]) which returns, for each r and f, respectively, retrieved from IR and IF, f copies of r. For instance, Duplicate(Step(5, 8, 1), [3]) returns {[5], [5], [5], [6], [6], [6], [7], [7], [7]}.

Provided hereinbelow are several examples that use these primitives to generate complex data distributions. The general form of a DGL expression is as follows:

| | |
|---|---|
| LET | v₁ = expr₁, |
| | v₂ = expr₂, |
| | ... |
| | vₙ₋₁ = exprₙ₋₁ |
| IN | exprₙ |

where each exprᵢ is a valid DGL expression that can refer to variables vⱼ. One restriction can be that the reference graph be acyclic (i.e., recursion is not allowed; however, the primitive iterator can be recursive). For instance, the following expression is an iterator that produces 65% of uniformly distributed rows and 35% of normally-distributed rows.

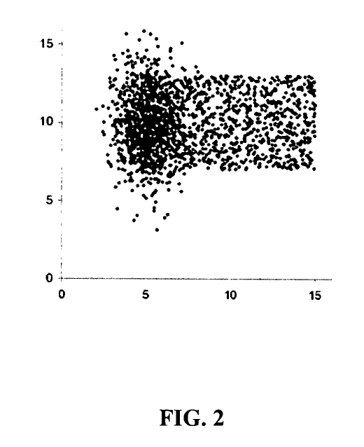

FIG. 2 shows graphically an output distribution of the following iterator in accordance with the subject invention.

LET count = 10000, P = 0.65,

U = Uniform([5,7], [15,13]),
N = Normal([5,5], [1,2])

IN Top( ProbUnion(U, N, P), count )

DGL includes functions. Functions in DGL are specified as follows:
function name(arg1, . . . , argn)=expr

where expr is a DGL expression. For instance, a function called simpleF can be defined which parameterizes the values count and P in the previous example, as follows:

simpleF (P, count) =

| | |
|---|---|
| LET | U = Uniform([5,7], [15,13]), |

N = Normal([5,5], [1,2])

IN Top( ProbUnion(U, N, P), count )

The distribution shown in FIG. 2 can then be obtained using a function defined as simpleF(0.65, 10000).

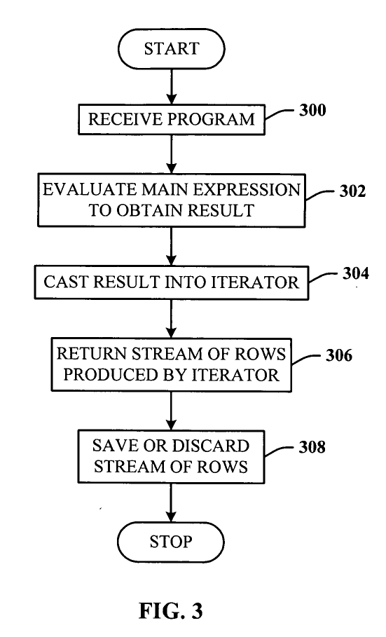

FIG. 3 illustrates a methodology of program evaluation in accordance with the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

A DGL program is a set of function definitions followed by an expression (called the main expression). At 300, a DGL program is received for processing. In DGL, evaluating a program is equivalent to evaluating its main expression to obtain a result, as indicated at 302. At 304, the result is cast into an iterator. At 306, the stream of all the rows produced by this iterator is returned. At 308, the stream of rows can then be either saved to a file, or discarded, if the program already generated tables in the RDBMS using Persist primitives.

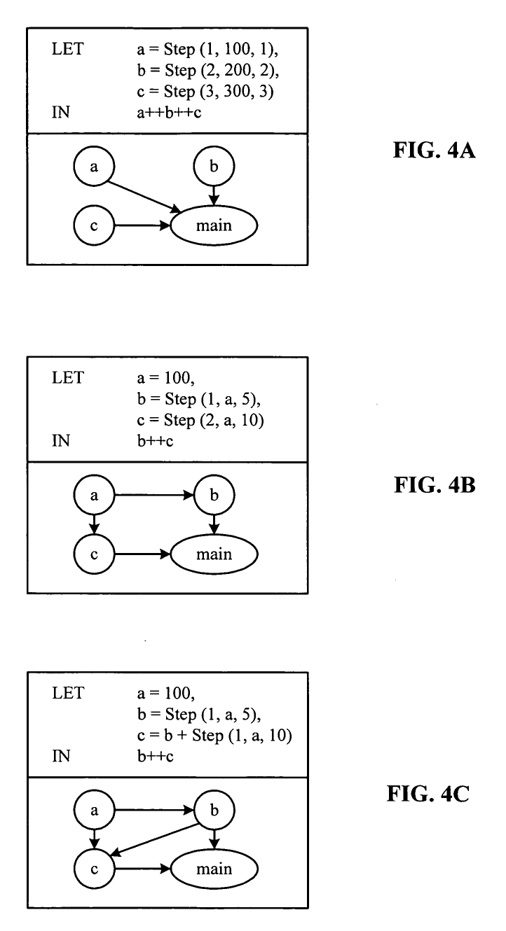

Evaluation of a DGL program can proceed as follows. In general, a DGL program can be seen as a directed acyclic graph (DAG). The DAG of a general expression can consist of one node (with label vᵢ) for each vᵢ=exprᵢ in the main expression, plus an additional node (with label main) for the IN expression exprₙ. There is a directed edge between nodes nᵢ and nⱼ if exprⱼ directly refers to vᵢ. If (nᵢ,nⱼ) is a directed edge in the DAG, nⱼ is said to be a consumer of nᵢ. FIGS. 4A-C show simple programs and their corresponding DAGs.

FIG. 4A illustrates a diagram of a simple DGL program and corresponding DAG where each node has exactly one consumer, in accordance with the invention. In FIG. 4A, the evaluation of the DGL program is straightforward. Each node produces objects that are passed to its unique consumer. Multiple iterators can be chained in this way and the memory footprint required to evaluate a program remains constant. Iterators with an internal state that can grow unbounded (e.g., dupFilterMem) cannot be memory-bounded, but this is unavoidable.

FIG. 4B illustrates a diagram of a simple DGL program and corresponding DAG where a node has multiple consumers, in accordance with the invention. The evaluation model is still valid even if some nodes in the DAG have multiple consumers, provided that such nodes are scalars or rows (e.g., node a in FIG. 4B is shared by nodes b and c). The reason is that scalars and rows in DGL are immutable and can be safely shared among consumers.

FIG. 4C illustrates a diagram of a simple DGL program and corresponding DAG where the same iterator has multiple consumers, in accordance with the invention. In the general case, if some iterator node has multiple consumers (e.g., node b in FIG. 4C) the situation is more complex. A problem is that the different consumers must see the same stream of rows from the shared iterator, but might request rows at different rates. DGL implements a buffering mechanism for that purpose (described infra). Note that in many common examples the actual speed of different consumers is the same, and therefore, the buffer is always of size one. In the example of FIG. 4C, each time main produces a new row, it requests the next row to both b and c. In this case, b is shared between main and c, so it must buffer the row that produces for main until c requests it. However, for c to generate the row required by main it requests the next row of b in sync with main. Therefore, although buffering is present in this example, it is not used beyond its first cell, and the memory footprint of the whole program remains constant.

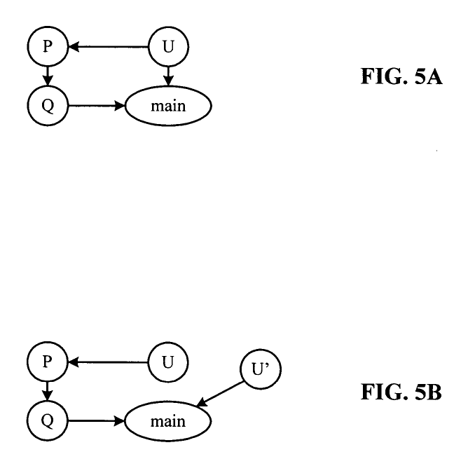

DGL offers a simple mechanism to allow a program to trade-off space consumption for performance in the presence of shared iterators via buffering or duplicating work. FIG. 5A shows a DAG of a buffering scenario in accordance with the invention. Consider the following program whose DAG is shown in FIG. 5A:

| | |
|---|---|
| LET | U = Step(1, 10000, 1), |
| | P = Persist(U), |
| | Q = Query(“complex query”, P) |
| IN | U ++ Q |

Due to the Persist operator, iterator U is consumed entirely when the first row from Q is requested. Therefore, U must buffer its entire stream to satisfy future requests from main. In this particular example, U simply produces integers of increasing value. A simple way to avoid the buffering of U is to duplicate U such that P and main request rows from different instances.

FIG. 5B illustrates a DAG of iterator duplication in accordance with the invention. Iterator duplication can be specified as follows:

| | |
|---|---|
| LET | U = Step(1, 10000, 1), |
| | U′ = Step(1, 10000, 1), |
| | P = Persist( U ), |
| | Q = Query(“complex query”, P) |
| IN | U′ ++ Q |

In this case each iterator node has at most one consumer and there is no buffering involved. Additionally, since the processing done by u is minimal, there is almost no additional overhead.

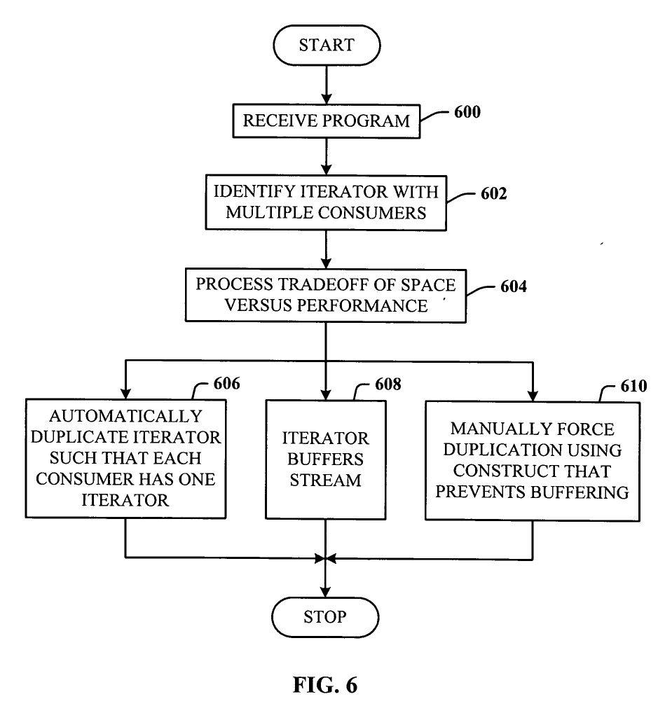

FIG. 6 illustrates a methodology of determining the trade-offs between buffering and duplication of a shared iterator in accordance with the invention. At 600, a program is received for processing to obtain a result. At 602, some intermediate iterator is shared by a multiplicity of consumers. At 604, the trade-offs are processed for determination. At 606, one option is to automatically duplicate the shared iterator such that each consumer thereof has one iterator. Alternatively, at 608, the iterator buffers the stream of rows. Unfortunately, in complex programs it is not always desirable to duplicate iterators, since each copy duplicates work. Moreover, due to primitive or user-defined operators with side effects, this alternative is not always correct. For those reasons, programs are not necessarily rewritten to avoid buffering. DGL can also provide a manual construct to prevent buffering at a given node. Thus, at 610, a manual construct is imposed to force duplication and prevent buffering.

If the name of an iterator variable is preceded by the ‘*’ sign, the corresponding iterator is not shared by multiple consumers, but a new instance is generated for each consumer. The above example can thus be rewritten as:

| | |
|---|---|
| LET | *U = Step(1, 10000, 1), |
| | P = Persist( U ), |
| | Q = Query(“complex query”, P) |
| IN | U ++ Q |

which is internally converted into the program shown earlier. When duplicating nodes that contain distribution primitives, such as Uniform, the compiler carefully seeds each primitive's random generator with the same value, to ensure that multiple executions return the same rows. For complex or user-defined iterators, the programmer should ensure correctness when duplicating iterators.

A thin layer on top of DGL can be provided that allows annotating a SQL DDL CREATE TABLE statement to additionally specify how to populate the created table. The syntax is as follows:

CREATE TABLE T (colₗ typeₗ, ..., colₙ typeₙ)
[ other CREATE TABLE options ]
POPULATE N AS ( (col₁¹, ... colₙ_{₁}¹ ) = exprₗ,

...
(col₁^{k} , ... colₙ_{ₖ}^{k} ) = exprₖ

)

where N is an integer that specifies an upper bound on the size of the created table, each column colⱼ in T is mentioned exactly once in the POPULATE clause, and exprᵢ is a DGL expression with some additional syntactic sugar.

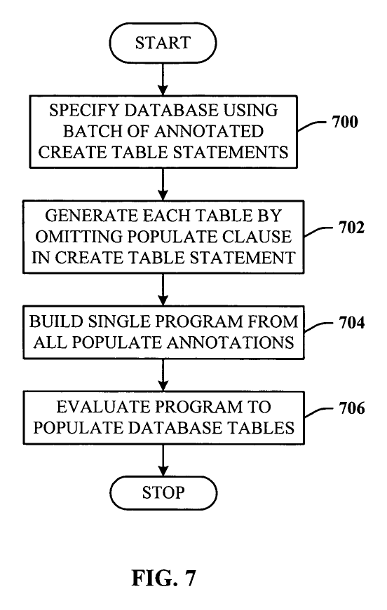

FIG. 7 illustrates a methodology of annotating a SQL CREATE TABLE statement in accordance with the invention. At 700, a database is specified using a batch of annotated CREATE TABLE statements, and is processed as follows. At 702, each table is created omitting the POPULATE clause in its CREATE TABLE statement. At 704, a single DGL program is built from all the POPULATE annotations. Finally, at 706, the DGL program is evaluated. As a side effect of its evaluation, database tables are populated.

In addition to plain DGL expressions, each exprᵢ in a CREATE TABLE statement can refer to columns of any other table in the batch (including the table that exprᵢ is populating) as if they were iterators. Additionally, temporary columns that are not part of the created table can be specified as well. Finally, the Query primitive can refer to any table in the batch and also can refer to the additional column id that is generated automatically by Persist. One restriction can be that the resulting DGL program must be valid (i.e., its corresponding DAG must be acyclic).

Following is a series of examples of how a DGL program is automatically generated from a batch of CREATE TABLE statements, thus significantly simplifying the task of the end user. Consider the following simple specification:

CREATE TABLE Test (a INT, b INT, c INT, d INT)
POPULATE 10000 AS (

(a, d) = myFunc(100),
b = c − 1,
c = a + d )

The generated DGL program defines one iterator for each expression in the specification above, combines each iterator in the right column order, truncates the result to 10000 rows, and persists it into table Test. Columns used within expressions are referred to as projections of the corresponding iterators. The resulting program is as follows:

| | |
|---|---|
| LET | Test_ad = myFunc(100), |

Test_b = Test_c[0] − 1,
Test_c = Test_ad[0] + Test_ad[1],
Test = Top( Test_ad[0] ++ Test_b[0] ++ Test_c[0] ++

Test_ad[1], 10000)

| | |
|---|---|
| IN | Persist(Test, “Test”) |

Evaluating this DGL program persists the specified data distribution into table Test. A set of multiple CREATE TABLE statements is treated in the same way. A single program is generated and the main expression combines each individual Persist primitive using ++. In this way, DGL can handle specifications in which some columns depend globally on the set of values of other columns, as shown in the next example (when Query primitives refer to the tables being populated, an additional mapping is applied.)

CREATE TABLE R (a INT, b INT, c INT, d INT) POPULATE 100000
AS (

(a,b) = myFunc1(10),
c = myFunc2 (20),
d = myFunc3 (30) )

CREATE TABLE S (f INT, g INT) POPULATE 5000 AS (

f = a+b,
g = Query(“SELECT AVG(b+c)

FROM R
GROUP BY a”) )

In this situation an additional expression is generated that as a side effect persists columns (R.a, R.b, R.c) into a temporary table (a Top operator is placed to ensure that the right number of rows is persisted). This temporary table is then used by the query that generates column S.f. Note that only R.a, R.b, and R.c are persisted instead of using the final populated table R to allow specifications in which columns from two tables mutually depend on each other's columns without forming a cycle in the DAG. If there is a partial order for the creation of tables in the batch, a simple optimization is can be employed in which the intermediate temporary table is not created at all.

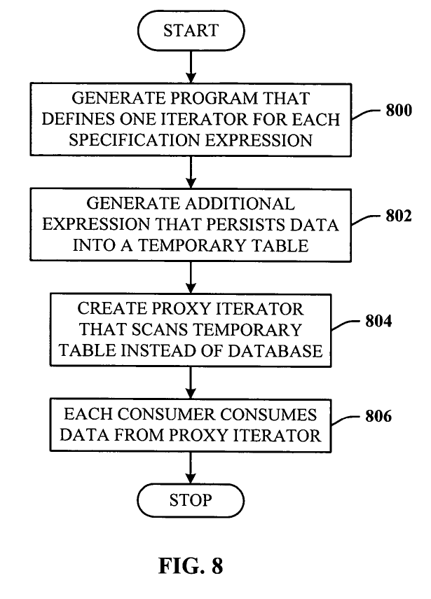

FIG. 8 illustrates a methodology of avoiding buffering iterators in accordance with the invention by employing an optimization which uses a proxy iterator. At 800, a program is generated that defines one iterator for each specification expression. At 802, an additional expression is generated that persists data into a temporary table. At 804, a proxy iterator is created that scans the temporary table in the database instead of requiring buffering. At 806, each consumer consumes data from the proxy iterator.

Continuing with the example, the optimization is used to avoid buffering the iterators for columns R.a, R.b, and R.c, since they are already persisted in the RDBMS. For that purpose, the proxy iterator is created that simply performs a sequential scan over the temporary table created by Persist. Each original consumer of columns R.a, R.b, or R.c is changed so that it consumes rows from this proxy iterator. The resulting program for the above specification is shown next.

| | |
|---|---|
| LET | R_ab = myFunc1(10), |

R_c = myFunc2(20),
R_d = myFunc3(30),
R_abcTmp = Persist(Top(R_ab ++ R_c, 100000)),
R_abcProxy= Query(“SELECT v0,v1,v2 from <0>”,

R_abcTmp),

S_f = R_abcProxy[0] + R_abcProxy[1],
S_g = Query(“SELECT v0, AVG(v1,v2)

FROM <0>
GROUP BY v0”, R_abcTmp),

| | R = Top(R_abcProxy ++ R_d, 100000), |
|---|---|
| | S = Top(S_f ++ S_g, 5000) |
| IN | Persist(R, “R”) ++ Persist(S, “S”) |

Note that the initial annotation on the CREATE TABLE statement can be simpler to understand and write than the corresponding DGL program. Several examples are provided infra that use annotated schemas to specify complex database distributions.

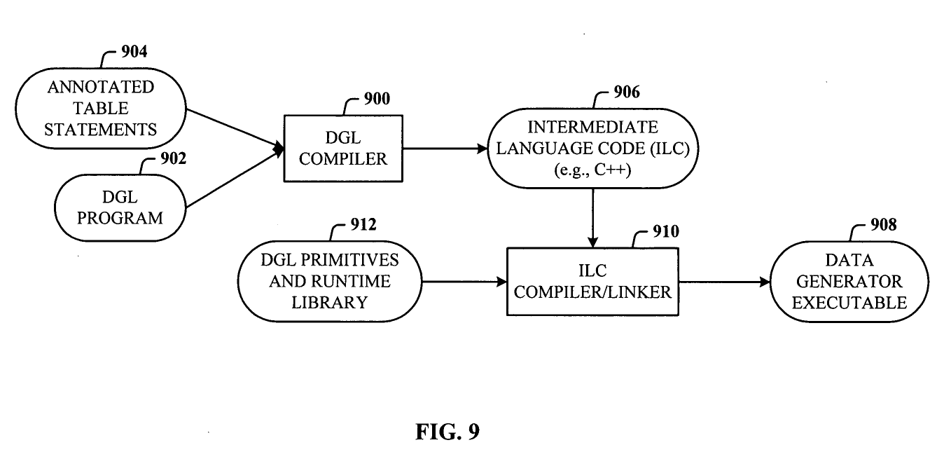

FIG. 9 illustrates one implementation of DGL in accordance with the subject invention. A DGL compiler 900 takes as input either a DGL program 902 or a set of annotated CREATE TABLE statements 904 and transforms the input into an intermediate language code (ILC) (e.g., C++ code). To obtain an executable data generator 908, the ILC is compiled and linked together using an ILC compiler/linker 910. The ILC compiles and links together with a runtime DGL library and any other user-defined libraries and DGL primitives 912. The resulting data generator executable 908 is then run to create and populate a database.

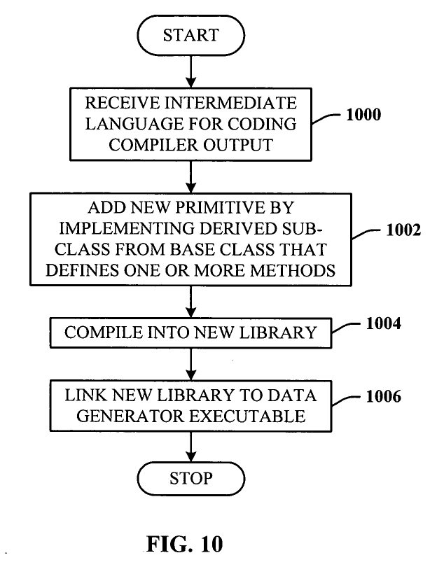

FIG. 10 illustrates a methodology for defining new primitives in DGL in accordance with the invention. At 1000, an intermediate language is received. A DGL program is first compiled into the intermediate language code (e.g., C++). To add a new primitive iterator to DGL, a derived subclass from the base class Iterator is implemented in the intermediate language that defines the methods open and getNext, as indicated at 1002. At 1004, the coded subclass is compiled into a new library. At 1006, the new library is subsequently linked into the final executable database generator.

The following illustrates how to implement a new primitive iterator aggSum, which incrementally returns the sum of all prefixes of its input iterator. The pseudo-code for aggSum is shown below.

| void aggSum : : open ( ) | |
|---|---|
| local (I : Iterator) | |
| 01 | I.open( ); |
| 02 | ouputRow = new Row( dim(I.outputRow) ); |
| 03 | for (i = 0; i < dim(outputRow); i++) |

| | |
|---|---|
| 04 | output Row[i] = 0; |

| bool aggSum : : getNext ( ) | |
|---|---|
| local (I.Iterator) | |
| 01 | moreResults = I.getNext( ) |
| 02 | if (moreResults) outputRow += I.outputRow; |
| 03 | return moreResults; |

If I=Step(1, 10, 1)++[2], then aggSum(I) returns {[1,2], [3,4], [6,6], [10,8], . . . , [45,18]}. In the implementation herein, the base class Iterator defines a variable outputRow of type Row that holds the current row and getNext returns a Boolean value indicating whether a new row was generated or an end-of-iterator was reached. The details can include buffering, as described hereinafter, but is omitted here for clarity.

As described supra, an iterator can have multiple consumers requesting rows at different rates. Since each consumer must obtain the same sequence of rows from the shared iterator, all rows sent to fast consumers are buffered until the slowest consumer requests them.

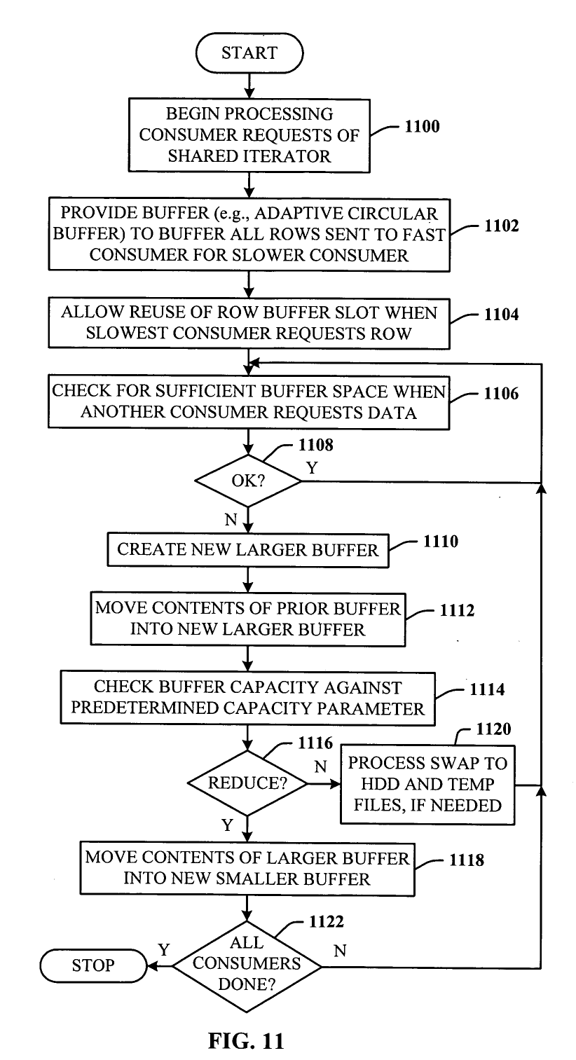

FIG. 11 illustrates a methodology of iterator buffering at runtime in accordance with the invention. At 1100, processing of consumer requests of a shared iterator is initiated. At 1102, a buffer technique (e.g., an adaptive circular buffer) is provided to buffer all rows that are sent to a fast consumer, for a slower consumer. At 1104, when a slowest consumer requests a row, the buffer slot associated therewith is freed for reuse. At 1106, the system then checks the available buffer space when another consumer requests data. If the existing buffer space is determined to be insufficient, as determined at 1108, flow is to 1110 to create a new larger buffer. At 1112, the contents of the existing smaller buffer are then moved into the new larger buffer. At 1114, the new larger buffer space is checked against a predetermined buffer capacity parameter. If the new larger buffer is being under utilized, it can be reduced, as indicated by flow from 1116 to 1118. At 1118, a new smaller buffer is created, and the contents of the new larger buffer are moved thereinto for more efficient buffer utilization.

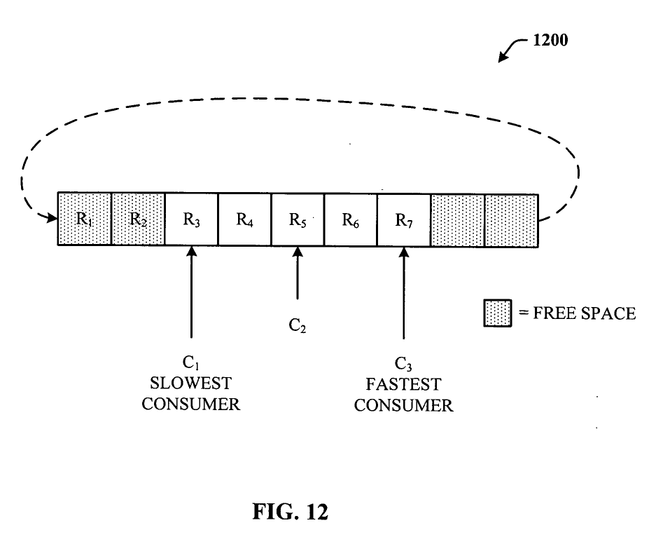

If the buffer capacity indicates that the new larger buffer should not be reduced, it may be that the larger buffer can be swapped from faster chip memory to the slower hard disk drive (HDD) storage, as indicated at 1120. Additionally, temporary files can be generated and processed, if needed. This is described below in FIG. 12. Progress is then back to 1106 to again, check for sufficient buffer space. Similarly, if the buffer space is sufficient, flow is from 1108 back to the input of 1106. At 1122, the system checks if the process is complete for all consumers. If so, the process ends. Alternatively, flow is back to 1106, as before.

FIG. 12 illustrates one implementation for proving buffering according to the invention. An adaptive circular buffer 1200 is provided wherein rows are associated with each iterator. The buffer 1200 maintains a window of the last rows produced by the iterator (e.g., rows R₃ to R₇ in the figure). Each consumer (C₁, C₂, and C₃) points to the last row it obtained from the buffer 1200 (e.g., consumer C₂ already read rows R₁ to R₅). When a consumer requests a new row and it does not point to the last valid row in the buffer 1200, the consumer's pointer is advanced and the corresponding row is returned (e.g., if C₂ requests a new row, its pointer moves to and returns row R₆). If instead the consumer points to the last valid row in the buffer 1200 (e.g., C₃), a new row is first produced and stored in the circular buffer 1200, and then returned to the consumer. When the slowest consumer requests a row (e.g., C₁ requests row R₃), the row's slot in the buffer is freed and reused.

Now suppose C₃ requests five new rows before C₁ requests any. In this case, there is no available buffer space for the fifth row. A new buffer (not shown) larger than the original buffer 1200 (e.g., twice a large) is then created and all the row elements are moved to this new larger buffer (ensuring constant amortized insertion time). When the slowest consumer requests a row and the buffer capacity falls below a predetermined capacity parameter (e.g., 25 percent), the new larger buffer is replaced by a new smaller buffer (e.g., one half its original size (ensuring constant amortized deletion time)).

The adaptive behavior of the buffer 1200 is not sufficient in general, since one consumer can always be faster than another, and the size of the circular buffer would grow unbounded. In this case the new increasingly larger buffer is swapped to disk after it has grown beyond a certain size. The original buffer is kept in faster chip memory, but all subsequent “insertions” are written into a temporary sequential file. After consumers exhaust the in-memory portion of the buffer, they continue scanning the temporary file. In one implementation, the RDBMS capabilities are not used for buffering because the OS file system is a light-weight and flexible alternative for this specific purpose. To avoid unnecessarily large temporary files, when the slowest consumer starts scanning the file, a new temporary file is created for all subsequent insertions. When the slowest consumer reads the last row of the current temporary file, the file is deleted. For many examples, though, consumers request data synchronously, so there is virtually no impact due to buffering.

In one implementation, an ODBC (Open Database Connectivity) interface is used to connect to a RDBMS and execute queries specified by the Query iterator (Query is a thin wrapper on top of ODBC, which natively supports the iterator model). The Persist operator uses ODBC's minimally logged bulk-loading extensions to maximize performance.

Following are examples of how to generate several databases previously proposed in the literature using DGL, thus, providing the motivation to employ the disclosed architecture, and establishing that DGL is scalable, flexible, and easy to use.

The Wisconsin Benchmark was proposed in the early 1980's to test the performance of the major components of a RDBMS, using relations with well-understood semantics and statistics. The following is a partial specification using DGL to generate a table TENKTUP of this benchmark.

CREATE TABLE TENKTUP ( ... )
POPULATE 10000 AS (

unique1 = Permutation(10000),
unique2 = Step(0, 10000, 1),
four = unique1 mod 4,
onePercent = unique1 mod 100,
oddOnePercent = onePercent * 2 + 1, ... )

where Permutation is defined as follows:

Permutation(n) =

LET tmp= PERSIST(Uniform(0, 1))
IN Query(“SELECT id FROM <0> ORDER BY v0”,tmp)

An alternative procedure can be used to generate permutations, which is based upon congruential generators that return dense uniform distributions. While this alternative is less costly and can easily be implemented it in DGL it can only be used to generate one different permutation (others are just circular shifts).

The AS³AP (ANSI SQL Standard Scalable and Portable) Benchmark is a successor of the Wisconsin Benchmark and gives a more balanced and realistic evaluation of the performance of a RDBMS. In addition to the tests performed by the Wisconsin Benchmark, AS³AP tests utility functions, mix batch and interactive queries and emphasize multi-user tests. From a data generation perspective, AS³AP introduces non-uniform distributions in some columns, but columns remain independently generated from each other. Shown is a partial DGL specification for an UPDATES table in the AS³AP benchmark.

CREATE TABLE UPDATES ( ... )
POPULATE 10000 AS (

key = 1 + Permutation(10000),
signed= 100000 * Permutation(10000) − 50000000,
float= 100000 * Zipfian(1.0, 10) − 500000000,
double= Normal(1, 0), 0, 1, [0], ... )

Note that the actual specification states that the value 1 must not appear in column key to allow “not-found-scans” for a value within the range of the attribute. For simplicity, the value 0 is omitted instead, which conveys the same functionality but makes the specification slightly simpler. Both columns signed and float are specified to be sparse, so that the distinct values are stretched to the range [−5·10⁸, +5·10⁸] and thus can be used to phrase queries with relative selectivities that are a function of the database size.

The Set Query Benchmark was designed to measure the performance of a new class of systems that exploit the strategic value of operational data in commercial enterprises. While the queries in the Set Query benchmark are complex, the data generation program is surprisingly simple (specifically, each column is populated independently with uniformly distributed integer values). Shown is a DGL specification for the BENCH table in this benchmark.

CREATE TABLE BENCH ( ... )
POPULATE 1000000 AS (

KSeq = Step(1, 1000000, 1),
K500K = UniformInt(1, 500000),
K250K = UniformInt(1, 250000),
...,
K2 = UniformInt(1, 2) )

The following section presents a sample of data distributions recently used in the literature to validate novel cardinality estimation techniques. The M-Gaussian synthetic distribution consists of a predetermined number of overlapping multidimensional Gaussian bells. The parameters for this distribution are: the domain for the Gaussian centers (Lo, Hi), the number of Gaussian bells p, the standard deviation of each Gaussian distribution sigma, and a Zipfian parameter z that regulates the total number of rows contained in each Gaussian bell. This distribution is specified below:

M-Gaussian(Lo, Hi, sigma, z, p) =

LET centerList = Top( Uniform(Lo, Hi), p )

indexes = Zipfian(z, p),
centers = TableApply(centerList, indexes)

IN Normal(centers, sigma)

where centerList generates p random Gaussian centers, indexes generates N indexes (which point to some center) and centers is an iterator that returns a stream of centers taken from centerList (for efficiency, the Gaussian centers are stored in an in-memory table, since by definition there are a small number of them). Finally, a Normal transformation is applied to the centers to obtain the desired distribution. Using the function defined above, the two-dimensional data set is generated as:

CREATE TABLE Test ( x REAL, y REAL, z REAL )
POPULATE 1000000 AS (

(x,y,z)= M-Gaussian([0,0,0], [1000,1000,1000],

[25,25,25], 1.0, 25 )
)

In M-Zipfian distributions, each dimension has a number of distinct values, and the value sets of each dimension are generated independently. Frequencies are generated according to a Zipfian distribution and assigned to randomly chosen cells in the joint frequency distribution matrix. The following DGL function returns cell indexes for a two-dimensional Multi-Zipfian distribution:

M-Zipfian2D ( N1, N2, z ) =

LET indexes = Zipfian(z, N1*N2),

mapIndexes= TableApply(Permutation(N1*N2),

indexes)
IN mapIndexes/N2 ++ mapIndexes%N2

where indexes chooses a random number between 1 and the number of cells in the joint distribution following a Zipfian distribution, mapIndexes applies a random permutation to the values in indexes, and the main expression unfolds each number in the two-dimensional coordinates of a cell. The result of M-Zipfian2D is a stream of cell-indexes, which can then be mapped to a valid element in the data domain.

A different data generation procedure derived from Zipfian distributions is a data generation program that produces N rows in d consecutive clusters of values whose frequencies follow a Zipfian distribution. A simple DGL specification for this generator is:

Consecutive-Zipf ( N, z, d ) =

Duplicate( Step(l, d, 1), ZipfianD(N, z, d) )

where ZipfianD generates at each step the i^{th} frequency of an ideal Zipfian distribution with parameter z(1≦i≦d) for a total of N rows.

JoinCorr. In the context of statistics on query expressions, data is generated that exhibits dependencies between filter and join predicates. A generator is used that populates a fact table R with a foreign-key to a dimension table S. It is chosen, in one implementation, that the number of matches in S from the foreign-key join from R follow a Zipfian distribution, and also that a column c in S maintained the number of elements in R that were joined with the corresponding row in S. The following DGL specification generates such distribution:

CREATE TABLE R (r INT, s REAL, ...)
POPULATE 1000000 AS (

r = Step(1, 1000000,1),
s = Zipfian(1.0, 50000),
... )

CREATE TABLE S ( s INT, c INT, ...)
POPULATE 50000 as (
(s, c) = Query(“SELECT s, count(*)
FROM R
GROUP BY s”),
... )

where the Query iterator in S returns all distinct values in R as well as their counts, which is precisely what is desired to be generated.

TPC-H (TPC (Transaction Processing Performance Council) Benchmark™H) is a decision support benchmark that consists of business oriented ad-hoc queries and concurrent data modifications. The data populating the database has been chosen to have broad industry-wide relevance while maintaining a sufficient degree of ease of implementation. While TPC-H defines rich schema and complex queries, the standard data generation tool is rather simple. Almost all columns are uniformly generated and, and with some exceptions, all columns are uncorrelated. (The exceptions are orders.o_totalprice, which is functionally determined by lineitem.l_tax, lineitem.l_discount, and lineitem.l_extendedprice, and columns of type date in lineitem, which must satisfy some precedence constraint.) In this section the schema of TPC-H is used and shown how to specify some complex dependencies for a TPC-H like database. For clarity, small fragments of DGL are presented instead of giving a full specification.

Order arrivals follow a Poisson distribution starting in ‘1992/01/01’. To specify this distribution, a Poisson iterator is used that returns inter-arrival times and aggregate it using aggSum (defined in Section 4.1). Finally, the resulting iterator is added to the constant iterator ‘1992/01/01’. The following code reflects this.

CREATE TABLE ORDERS (...) POPULATE N AS ( o_orderdate =

‘1992/01/01’ + aggSum( Poisson(5) ),

... )

The number of line items for a given order follows a Zipfian distribution (i.e., there are some very large orders and many small ones). Additionally, the ship date of an item occurs after k days of the order date, where 1≦k≦10 follows a Zipfian distribution with parameter z=1.75. Finally, the commit and receipt dates of an item follow a two-dimensional normal distribution centered around five days after the ship date. Receipt and commit dates could be earlier than the ship date. To avoid this rare situation, a MAX operator can be added so that l_commitdate and l_receiptdate always occur after l_shipdate. The following code shows a possible DGL specification.

CREATE TABLE LINEITEM (...) POPULATE N AS (

(l_orderkey, tmpDate) = Duplicate( Query(“SELECT o_orderkey,

o_orderdate FROM ORDERS”), Zipfian(1.0, 1000) ),

l_shipdate = tmpDate + Zipfian(1.75, 10),
(l_commitdate, l_receiptdate) = Normal([0,0],[1,1]) + [5 +
l_shipdate, 5 + l_shipdate],
... )

Essentially, l_orderkey is defined by selecting all keys from orders and duplicating each one a certain number of times (specified by a Zipfian distribution). Note that a temporary column tmpDate can be specified, which is not persisted into the final database. Instead, tmpDate is used to define l_shipdate, which in turn is used to define both l_commitdate and l_receiptdate.

The discount of each lineitem is correlated to the number of such parts sold globally. Specifically, let |P| be the number of parts equal to that of lineitem that are globally sold. If |P| is beyond 1000, the discount for the lineitem should be 25%. Otherwise, the discount should be |P|*0.025%. The following code shows how this can be achieved in DGL.

CREATE TABLE LINEITEM (...) POPULATE N AS (

l_partkey = ...,
l_discount = Query(“SELECT CASE WHEN

pTotals.pCount>1000 THEN 0.25

ELSE pTotals.pCount*0.00025

END

FROM LINEITEM L,

( SELECT l_partkey, COUNT(*) as pCount
FROM LINEITEM
GROUP BY l_partkey ) as pTotals

WHERE L.l_partkey = pTotals.l_partkey
ORDER BY L.id”),

... )

A Query iterator is used that computes the total number of each distinct part value in LINEITEM, and then join this “aggregated” table with the partially generated LINEITEM, computing the discount of each row. Note the final order clause in the Query iterator(ORDER BY L.id). This is used to guarantee that the “discount” iterator is in sync with the other columns in lineitem, since the join in the Query iterator might be non-order-preserving.

Assuming that customers pay an order whenever it is closed, the debt of a customer is defined as the total price of all its still-open orders. It is desired that the top 100 customers (e.g., the 100 customers with the largest debt) to have a balance that is normally distributed around three times their respective debts with a standard deviation of 25000. The remaining customers' balances follow a normal distribution around half its debt with a standard deviation of 500. The following code shows a DGL fragment to obtain such distribution.

CREATE TABLE CUSTOMER (...) POPULATE N AS (

(c_custkey, tmpDebt) = Query (“

SELECT o_custkey, sum(o_totalprice) as sumPrice
FROM ORDERS
WHERE o_orderstatus=‘O’
GROUP BY o_custkey
ORDER BY sumPrice desc”)

c_acctbal = Union ( Normal( Top(TmpDebt, 100) * 3,
25000 ),

Normal( Skip(TmpDebt, 100) / 2, 500 )
)

... )

First, the customer keys are generated using a Query iterator that additionally returns the “debt” of each customer in a temporary column tmpDebt. Next, c_acctbal is generated as the union of two iterators. The first one gets the top 100 rows from tmpDebt and produces the corresponding normal distribution, while the second one does the same to the 101st row of tmpDebt and beyond (using for that purpose the primitive iterator Skip).

It is desired to model the fact that all parts in an order are sold by suppliers that live in the same nation as the customer. For this example, assume that l_orderkey was already generated with some distribution, and generate the complementary distributions for l_suppkey (a random supplier from the same nation as the orders' customer), and l_partkey (a random part from that supplier). The following code shows a possible DGL specification.

CREATE TABLE LINEITEM (...) POPULATE N AS (

tmpNation = Query (“ SELECT c_nationkey

FROM LINEITEM, ORDERS, CUSTOMER
WHERE l_orderkey=o_orderkey and

o_custkey=c_custkey

ORDER BY LINEITEM.id ” ),

l_suppkey = Query(“ SELECT S.s_suppkey

FROM LINEITEM CROSS APPLY (

SELECT TOP 1 s_suppkey
FROM SUPPLIER
WHERE s_nationkey = tmpNation
ORDER BY newid( ) ) as S ”) ,

l_partkey = Query(“ SELECT PS.ps_partkey

FROM LINEITEM CROSS APPLY (

SELECT TOP 1 ps_partkey
FROM PARTSUPP
WHERE ps_suppkey = s_suppkey
ORDER BY newid( ) ) as PS” )

... )

First, define a temporary column tmpNat ion which consists of the nations of the corresponding orders' customers. Then, define l_suppkey with a Query iterator that uses the extended SQL CROSS APPLY and newId operators. CROSS APPLY invokes a table-valued function for each row in the outer table expression and returns a unified result set out of all of the partial table-valued results. newId returns a random identifier for each row in the result. Essentially, it selects at random one row from SUPPLIER that has the same nation as each row in tmpNation. A similar iterator is used to select a random part from each element in l_suppkey. If the SQL extensions CROSS APPLY and newId are unavailable in the underlying DBMS, or if another (non-uniformly distributed) distribution of parts per supplier is desired, a more complex DGL program is needed. Such details are omitted for brevity.

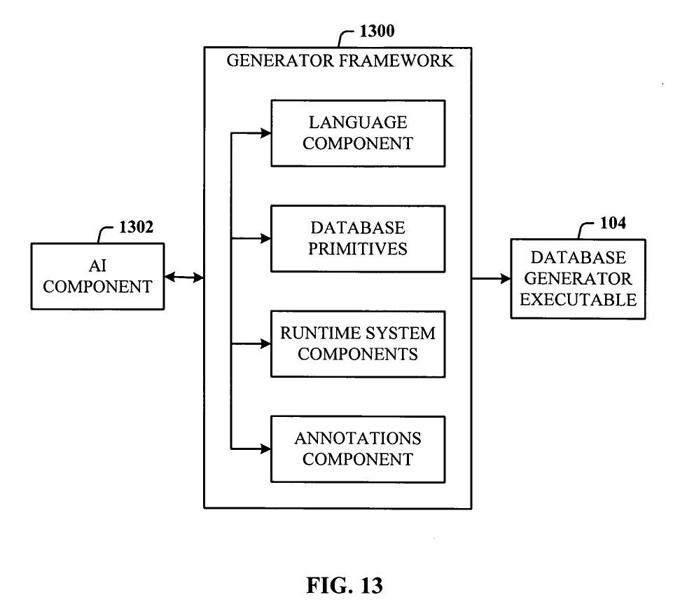

FIG. 13 illustrates a database generation framework 1300 that utilizes an artificial intelligence (AI) component 1302 to learn and automate one or more features in accordance with the invention for eventual creation of the database generation executable file 104. The subject invention (e.g., in connection with selection) can employ various AI-based schemes for carrying out various aspects thereof. For example, a process for determining when to duplicate iterators versus buffer data streams can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to the following: automatically adjusting default or previously learned criteria or parameters that are used to determine when to increase or decrease the size of the buffer memory; when to swap memory contents onto the HDD, and back, when to duplicate interators instead of buffering, and so on. These are only a few of the features or aspects of the subject invention that can be analyzed, learned, and automated. Other aspects thereof described herein are also within contemplation of processing with the AI component 1302.

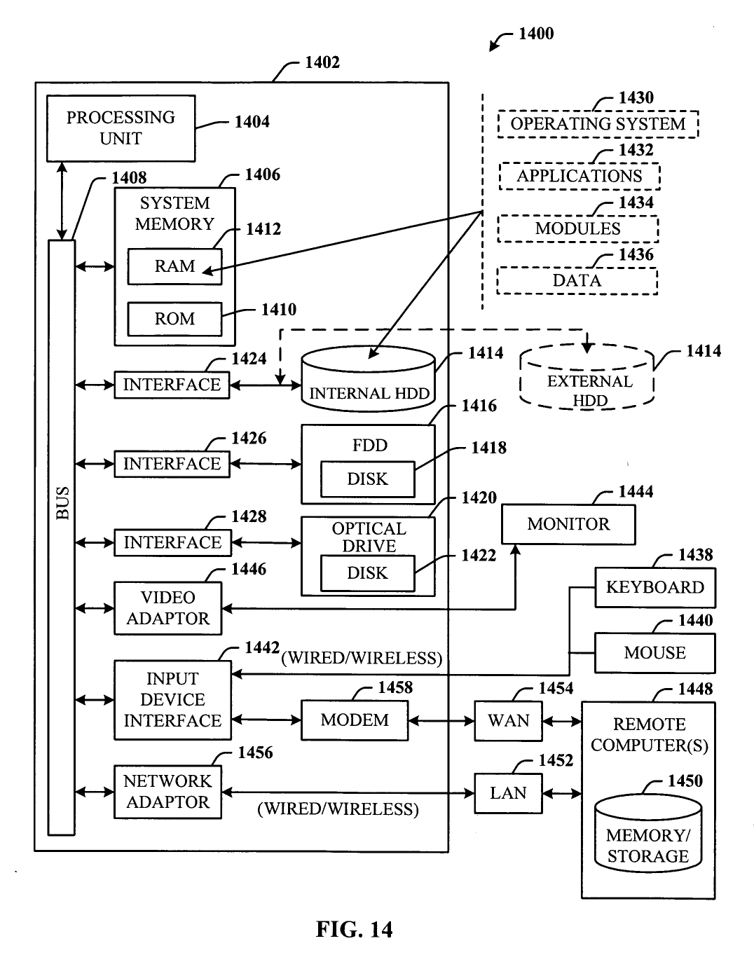

Referring now to FIG. 14, there is illustrated a block diagram of a computer operable to execute the disclosed architecture. In order to provide additional context for various aspects of the subject invention, FIG. 14 and the following discussion are intended to provide a brief, general description of a suitable computing environment 1400 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 14, there is illustrated an exemplary environment 1400 for implementing various aspects of the invention that includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the invention can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1402 is connected to the local network 1452 through a wired and/or wireless communication network interface or adapter 1456. The adaptor 1456 may facilitate wired or wireless communication to the LAN 1452, which may also include a wireless access point disposed thereon for communicating with the wireless adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

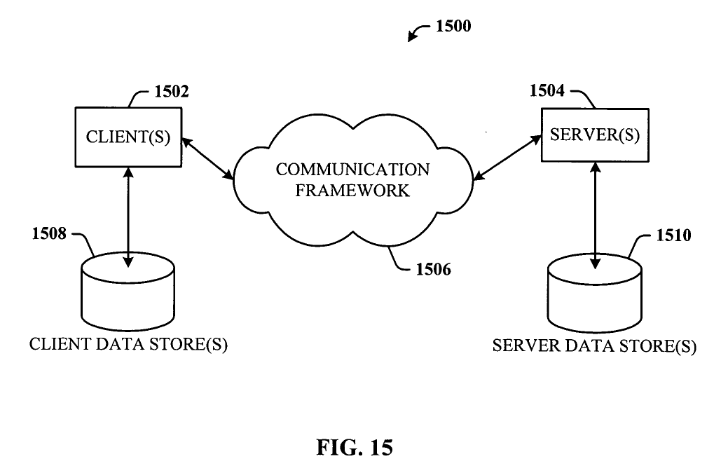

Referring now to FIG. 15, there is illustrated a schematic block diagram of an exemplary computing environment 1500 in accordance with the subject invention. The system 1500 includes one or more client(s) 1502. The client(s) 1502 can be hardware and/or software (e.g., threads, processes, computing devices). The client(s) 1502 can house cookie(s) and/or associated contextual information by employing the invention, for example.

The system 1500 also includes one or more server(s) 1504. The server(s) 1504 can also be hardware and/or software (e.g., threads, processes, computing devices). The servers 1504 can house threads to perform transformations by employing the invention, for example. One possible communication between a client 1502 and a server 1504 can be in the form of a data packet adapted to be transmitted between two or more computer processes. The data packet may include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated via a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates generation of a data distribution, comprising:
a framework which facilitates generation of the data distribution, which data distribution includes at least one of a complex intra-table correlation and a complex inter-table correlation.

2. The system of claim 1, wherein the data distribution is synthetic.

3. The system of claim 1, wherein the framework is scalable.

4. The system of claim 1, further comprising an annotations component that facilitates annotation of a relational database statement which specifies concisely how a table will be populated.

5. The system of claim 4, wherein the statement is a CREATE TABLE statement.

6. The system of claim 1, further comprising a language component that specifies the data distribution, which is a synthetic data distribution.

7. The system of claim 6, wherein the language component utilizes scalars, a fixed-size heterogeneous sequence of the scalars, iterators, and tables.

8. The system of claim 6, wherein the language component facilitates generation of a program that interfaces to a relational database management system (RDBMS) to process RDBMS algorithms.

9. The system of claim 6, wherein the language component applies an implicit cast to an operand depending upon context of an expression.

10. The system of claim 6, wherein the language component is extensible such that a basic set of primitive iterators can be extended with a new user-defined iterator.

11. The system of claim 10, wherein the basic set of primitive iterators includes a statistical distribution iterator.

12. The system of claim 10, wherein the basic set of primitive iterators includes at least one of a discrete data distribution iterator and a continuous data distribution iterator.

13. The system of claim 1, further comprising an artificial intelligence (AI) component that employs a probabilistic and/or statistical-based analysis to prognose or infer an action that a user desires to be automatically performed.

14. A computer that employs the system of claim 1.

15. A server that employs the system of claim 1.

16. A system that facilitates generation of a data distribution, comprising:
a framework which facilitates creation of a database generator, which database generator outputs the data distribution, the data distribution is synthetic and includes a complex inter-table correlation, the framework comprising,
a language component that facilitates specification of the data distribution;
an annotations component that facilitates annotation of database statements; and
a runtime component that facilitates linking to at least one of a runtime library and a primitive iterator when creating the database generator.

17. The system of claim 16, further comprising a buffer that facilitates buffering a stream of data of a shared iterator.

18. The system of claim 17, wherein the buffer is dynamically increased or reduced in size according to an amount of row data stored therein.

19. The system of claim 16, wherein the specification includes a plurality of the database statements which are annotated.

20. The system of claim 16, wherein the data distribution includes an intra-table correlation.

21. A computer readable medium having stored thereon computer executable instructions for carrying out the system of claim 16.

22. A computer-readable medium having computer-executable instructions for performing a method of creating a data distribution, the method comprising:
providing a specification of the data distribution via a data generation language (DGL), the data distribution is synthetic and includes inter-table correlations;
creating at least one of, a DGL program that includes function definitions and an expression, and a set of annotated database statements;
compiling the DGL program into an intermediate code;
compiling the intermediate code to obtain a data generator; and
executing the data generator to output the synthetic data distribution.

23. The method of claim 22, further comprising providing iterators which can be combined and modified to obtain the inter-table correlations.

24. The method of claim 22, further comprising compiling the intermediate code with a compile/linker that links the intermediate code with runtime libraries and user-defined libraries.

25. The method of claim 22, further comprising adding a new primitive iterator to the DGL by;
providing a derived sub-class from a base class iterator that defines one or more methods; and
compiling the derived sub-class into a new library that is linked into the data generator.

26. The method of claim 22, wherein the DGL includes an iterator having multiple consumers that request row data at different rates.

27. The method of claim 26, further comprising buffering with a buffer the row data that is requested by a fast consumer until a slowest consumer requests the row data.

28. The method of claim 27, further comprising,
dynamically creating a new larger buffer when additional buffer space in the buffer is needed for the row data; and
dynamically moving contents of the new larger buffer to a smaller buffer when buffer capacity of the new larger buffer is below a predetermined capacity parameter.

29. The method of claim 22, further comprising duplicating an iterator of the DGL such that each of multiple consumers thereof request row data from different iterator instances.

30. The method of claim 22, further comprising providing a manual construct of the DGL that forces duplication of the iterator such that each consumer is associated with only one instance of the iterator.

31. The method of claim 22, wherein the database statements are SQL relational statements.

32. The method of claim 22, further comprising evaluating the DGL program to automatically populate database tables with row data.

33. The method of claim 22, further comprising,
creating a proxy iterator of the DGL to avoid buffering of data; and
directing consumers of the data to the proxy iterator.
